(19) United States
(12) Patent Application Publication
(10) Pub. No.: US 2012/0107668 A1
(43) Pub. Date: May 3, 2012

(54) PRISMATIC BATTERIES AND ELECTRONIC COMPONENTS COMPRISING A STACK OF INSULATED ELECTRODE PLATES

(75) Inventors: Pui Tsang Peter Ling, Hong Kong (CN); Sung-On Andrew Ng, Hong Kong (CN)

(73) Assignee: GP Batteries International Limited, Kwai Chung, New Territories (HK)

(21) Appl. No.: 13/382,239

(22) PCT Filed: Jul. 7, 2010
(86) PCT No.: PCT/IB2010/053108

§ 371 Date: Jan. 4, 2012

(30) Foreign Application Priority Data
Jul. 7, 2009 (HK) 09106127.4

(51) Int. Cl. H01M 6/46; H01G 9/058; H01G 9/00; H01M 4/04

(52) U.S. Cl. 429/152; 29/623.1; 29/25.03; 361/500

(57) ABSTRACT

A prismatic battery cell or an electronic component comprising an electrode plate group of alternately stacked positive and negative electrode plates, wherein adjacent electrode plates of opposite polarity are insulated by an insulating separator, and electrode plates of one polarity are bent to converge at a common joining location for connecting together as a lead portion, the lead portion being joined together to a current collector of that one polarity, characterized in that the electrode plates are bent after the electrode plates are stacked and held or bundled together. Shaping the electrode plates to form the lead portions while the electrode plates are held in a stack means it is not necessary to handle pre-shaped electrode plates, since handling pre-shaped electrode plates in a production line could be tedious because the electrode plates are quite easily deformable.

### FIELD OF THE INVENTION

The present invention relates to prismatic batteries and, more particularly, to electrode plate groups of prismatic batteries. The present invention also relates to electronic components such as capacitors which comprise stacked electrode plates.

### BACKGROUND OF THE INVENTION

Prismatic batteries are generally of a prismatic shape. A typical prismatic battery comprises a plurality of battery cells, each of which comprises an electrode plate group of electrode plates of opposite polarity which are stacked together. The active region of an electrode plate group is generally prismatic and formed by stacking a pile of electrode plates in which the active areas of each electrode plate are identical and generally rectangular. The electrode plates are stacked such that positive and negative electrode plates are alternately stacked, and the active surfaces are aligned to maximally overlap.

Each electrode plate group of a prismatic battery comprises a positive plate group and a negative plate group, which are connected respectively to a positive current collector and a negative current collector to provide a current path. An electrode plate is typically formed initially as a planar sheet and is then bent to converge at a joining location so that edges of electrode plates of the same polarity can be joined. The converged ends of the electrode plates are then joined to a current collector by welding or other bonding techniques, and positive and negative current collectors are connected to a positive terminal and a negative terminal respectively.

Although most prismatic batteries have a rectangular or circular cross section, it will be appreciated that prismatic batteries can be of any appropriate prismatic shape without loss of generality.

Traditionally, electrode plates are bent before stacking, because bending after stacking would result in a lower yield rate, for example, due to piercing of an insulating separator between electrodes of the opposite polarity which will result in wastage of an entire battery cell or battery. On the other hand, pre-bending of electrode plates means additional processing steps and more complicated handling of the bent parts are required and this compatible with production economy.

Therefore, it would be advantageous if an improved method of making electrode plate groups or electronic components including a stack of electrode plates of opposite polarity could be provided.

### SUMMARY OF THE INVENTION

According to the present invention, there is provided a method of forming an electrode plate group of a battery cell or of an electronic component, the electroplate group comprising a stack of positive and negative electrode plates which are alternately stacked and insulated, the method comprising the steps of stacking positive and negative electrode plates alternately with insulators there-between, holding or bundling the electrode plates together in a stack, shaping the electrode plates or leads thereof such that electrode plates of an electrical polarity could be subsequently joined together to form a lead portion of that electrical polarity, and connecting electrode plates of the same electrical polarity together such that the positive and negative electrode plates are connected respectively to positive and negative lead portions, connecting the positive and negative lead portions to positive and negative current collectors of the battery cell respectively; characterized in that, the electrode plates are shaped to formed the lead portions while being held in the stack. Shaping the electrode plates to form the lead portions while the electrode plates are held in a stack means it is not necessary to handle pre-shaped electrode plates, since handling pre-shaped electrode plates in a production line could be tedious because the electrode plates are quite easily deformable. Also, formation of the lead portions after the electrode plates have been stacked means that the stack of electrode plates could be formed more efficiently and more precisely.

To alleviate the tedious steps of stacking pre-shaped electrode plates and then aligning same such that electrode plates of one polarity meet, the electrode plates of an electrical polarity may be shaped by bending to converge at the lead portion of that electrical polarity while in the stack. More conveniently, an electrode plate in the stack may be shaped to converge at the lead portion by bending about a straight elongate edge.

To facilitate convenient production, all electrode plates of one electrical polarity in the stack may be bent in a single step to converge towards the lead portion of that polarity. More particularly, positive and negative electrode plates in the stack may be bent in a single step to converge respectively towards positive and negative lead portions of the stack.

More specifically, the method may comprise the steps of Introducing a plurality of spacers into the stack of electrode plates before the electrode plates are held or bundled together, each spacers defining an elongate edge, bending the electrode plates about the spacers such that electrode plates of the same electrical polarity converge towards a common joining location, joining electrode plates of the same electrical polarity to form a lead portion of that polarity; and removing the spacers after the electrode plates having been joined. Using spacers, for example, ruler-like steel spacers, provides a very convenient and efficient means for forming the lead portion of an electrode plate group.

For example, each spacer may be placed intermediate an electrode plate and an insulating sheet. In other words, each spacer may be placed intermediate a positive plate and a negative electrode plate as an insulating sheet is intermediate electrode plates of opposite polarity; This mitigates the risk of damaging insulation between the electrode plates while bending.

The stack of electrode plates comprising the spacers may be held under compression when the electrode plates are bent to prevent bulging or dislocation of the electrode plates. This mitigates the risk of electrode plate dislocation, or plate bulging or deformation during lead portion formation.

To further enhance operational efficiency, the spacers may be removed in a single step after the lead portions have been formed and connected to the current collectors.

In an embodiment, the method may comprise placing the spacers such that each spacer overhangs an electrode plate of one polarity while being overhung by an electrode plate of the opposite polarity, bending the overhanging portions of the electrode plates about the corresponding edges of the respective spacers to converge at the common joining location, joining the overhanging portions of the electrode plates of the same polarity to form a lead portion of that polarity; and connecting the lead portions to the respective current collectors. This provides a useful and efficiency method of forming a prismatic battery with high precision.

As an example, each spacer may be elongate with a rigid rectilinear edge, the rigid rectilinear edge being adapted for bending of an electrode plate or a lead portion thereof such that the bent portion converges towards the common joining location. The rectilinear edge of a spacer may substantially parallel to the edges of the electrode plates in contact to form a neat and tidy electrode stack. A parallel edge also facilitates easy insertion and removal of the spacers.

The electrode plates of opposite polarity are separated by an insulating separator, and the spacers may be placed such that the rectilinear edges of the spacers are flush with a longitudinal side of an insulating separator in contact. This also mitigates unsightly folding of the insulating sheets.

As an example, the electrode plates may be clamped by a clamping mechanism to form an electrode stack before shaping of the electrode plates, and the method comprises operating the clamping mechanism to compress the electrode plates while the spacers are in place.

For example, the method may further comprise the step of aligning the spacers in the electrode stack so that the rectilinear edges of the spacers adjacent a current collector are aligned or flush.

It is another aspect of the present invention to provide a prismatic battery cell or an electronic component comprising an electrode plate group made according to any of the above. The electronic components may be a capacitor.

According to another aspect of the present invention, there is provided a prismatic battery cell or an electronic component comprising an electrode plate group of alternately stacked positive and negative electrode plates, wherein adjacent electrode plates of opposite polarity are insulated by an insulating separator, and electrode plates of one polarity are bent to converge at a common joining location for connecting together as a lead portion, the lead portion being joined together to a current collector of that one polarity, characterized in that the electrode plates are bent after the electrode plates are stacked and held or bundled together.

In an embodiment, each electrode plate comprises a planar active region and the transition from the planar active region of an electrode plate to the common joining location may be rounded and smooth. This mitigates excessive stress and tension at the transition which may affect the life our durability of a battery.

### BRIEF DESCRIPTION OF THE DRAWINGS

Preferred embodiments of the present invention will be explained in further detail below by way of examples and with reference to the accompanying drawings, in which:-

FIG. 1 is a side view of alternately stacked positive and negative electrode plates with a spacer in place,

FIG. 2 is a schematic side view of the stack of electrodes of FIG. 1 after the overhanging portions have been joined together and with spacers therein,

FIGS. 2A to 2D respective depict schematically formation of a connected electrode group from the stack of FIG. 1 to the connected stack of FIG. 2,

FIG. 3 is a schematic side view of the stack of electrodes of FIG. 1 after shaping but before the overhanging portions are joined together, (spacing between adjacent components is added for illustration only),

FIG. 4 is a side view of the stack of electrode plates of FIG. 2 after removal of the spacers,

FIG. 5 shows another embodiment of a stack of joined electrodes with a different bending angle compared to that of FIG. 4,

FIG. 6A to 6C show the steps to remove the spacers from the stack of welded electrodes,

FIG. 7 shows a welded electrode stack with post-bent overhanging portions with spacers removed,

FIG. 8 shows an electrode stack with pre-bent overhanging portions,

FIG. 9 is an image showing an end view of a stack of electrodes held together by a clamping fixture with the spacers in place,

FIG. 10 is a top plan view of FIG. 9,

FIGS. 11 & 12 are top perspective views of FIG. 8 from one end,

FIG. 13 is an image showing a spacer removing pin aligned with apertures of the spacers,

FIG. 14 is an image showing the removal of a substantial portion of the spacers from the stack of FIG. 13, and

FIG. 15 is an image showing an enlarged side view of a welded electrode plate group with spacers removed

### DETAILED DESCRIPTION OF THE PREFERRED EMBODIMENTS

The forming of an electrode plate group of a rectangular prismatic Nickel Metal Hydride (NiMH) battery cell of the present invention will be illustrated as a non-limiting example below with reference to the Figures.

A typical prismatic battery comprises a plurality of prismatic battery cells which are connected together to meet a required power and/or voltage rating. Each battery cell comprises an electrode plate group of alternately stacked positive and negative electrode plates, and insulating separators are placed between electrode plates of opposite polarities to provide insulation. Each electrode plate includes an active portion and a lead portion. The active portion is usually an area on an electrode plate, which is coated with active substances on which electrochemical reaction will take place during battery charging or discharging. The active portions of the plurality of electrode plates of an electrode stack are substantially overlapping, and the active region of an electrode plate group, which is the totality of and the active regions of an electrode plate group is generally prismatic.

For a typical NiMH rechargeable battery, the electrode plate comprises a Nickel foam substrate, the active areas of a positive electrode plate are coated with Nickel hydroxide as the main active substance, the active areas of the negative electrode plate are coated with a hydrogen absorbing alloy as the active substance, and the separator is usually a polypropylene sheet.

More particularly, for the electrode plate group herein, the active areas of the positive electrode plates are made of a nickel-foamed metal coated with nickel hydroxide, and the active areas of the negative electrode plates are made of a nickel punched metal sheet coated with negative electrode constituting materials such as a hydrogen-absorbing alloy. The electrode plates are typically very thin to reduce material costs and weight, since the electro-chemical reaction involved in the battery operation of charging and/or discharging is primarily surface in nature. Also, only the active areas are coated with the active substances to maximize cost benefits. The active areas of an electrode plate are primarily the regions on the electrode plate which substantially overlap with adjacent electrode plates of the opposite polarity.

The lead portions of the electrode plates of the same polarity are connected to a current collector of the same polarity, and current collectors of the same polarity are then connected to a battery terminal of that polarity to complete the current path. A current collector is usually made of nickel- plated copper or steel for good thermal and electrical conductivity. For prismatic battery cells in which the electrode plates are connected to the current collectors by electronic beam welding, resistance welding or carbon dioxide laser welding, the current collectors are typically thin nickel-plated metallic plates since the actual welding junction is behind the approaching surface of the welding source.

The lead portion of an electrode plate is generally a transversal extension of the active area of an electrode plate and comprises primarily of the substrate materials which is primarily a conductor provided to facilitate current conduction between the active portion of an electrode plate and a corresponding current collector. For a rectangular electrode plate, the lead portion is therefore also substantially rectangular, and the long sides of the lead regions of electrode plates of the same polarity are permanently connected together and to a current collector. To enable the plurality of lead portions to connect to a current collector, the lead portions of the electrode plates of the same polarity are bent to converge at a joining location and are bundled together at that joining location so that a permanent electrical connection of the electrode plates of the same polarity could be made, for example, by welding.

To form an electrode plate group 100 of a prismatic battery cell of an exemplary embodiment of the present invention, an electrode plate stack comprising a plurality of electrode plates of opposite polarity is formed first. In this specification, the term polarity means electrical polarity unless the context otherwise requires.

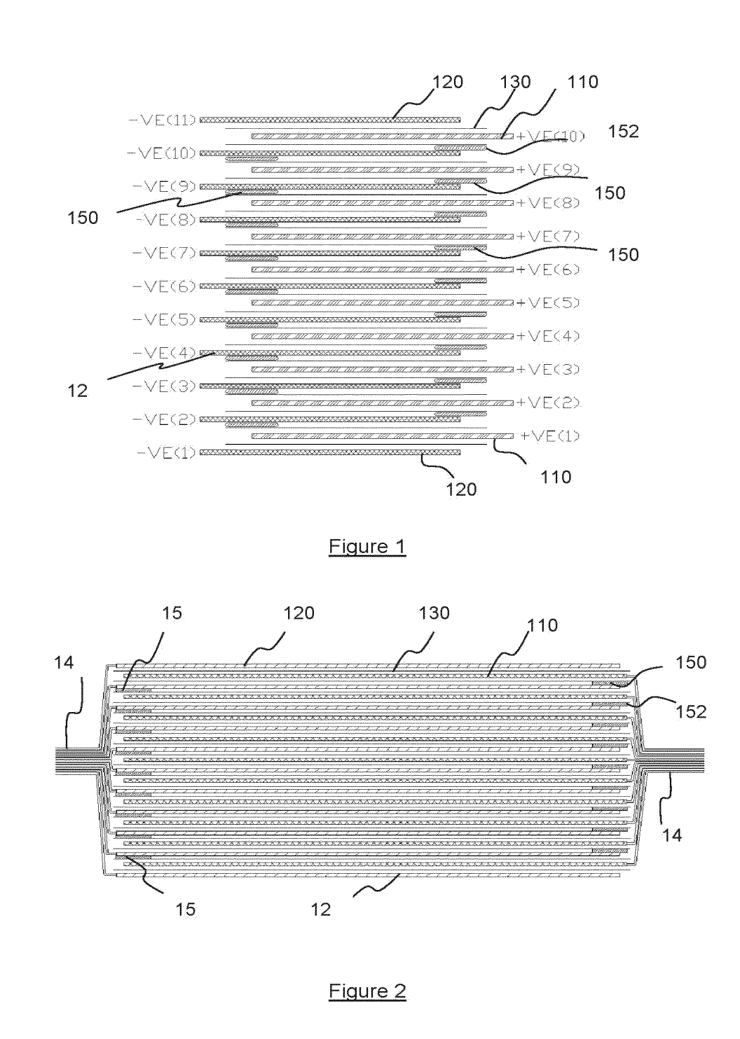

The pre-shaped electrode plate stack of FIG. 1 includes rectangular positive electrode plates 110 and negative electrode plates 120 which are alternately stacked. A polypropylene sheet 130 as an example of an insulating separator is placed intermediate electrode plates of the opposite polarity to prevent short-circuiting. The electrode plates 110, 120 are stacked such that electrode plates of one polarity overhang the electrode plates of the opposite polarity on one side of the stack. The overhanging portions will be shaped and connected together to form a lead portion of a polarity to be explained in more detail below. More specifically, negative electrode plates 120 overhang positive electrode plates 110 on the left side of the stack of FIG. 1, while positive electrode plates 110 overhang negative electrode plates 120 on the right side of the stack.

A steel guide or ruler 150 as an example of an edge forming spacer is placed intermediate electrode plates of the opposite polarity. More particularly, spacers are placed immediately above and below a negative electrode and insulating sheets are placed above and below a subgroup of a pair of spacers and a pair of electrode plates. As shown in FIG. 1, a spacer on the right side of the stack overhangs a negative electrode in contact, and the negative electrode overhangs a spacer in contact on the left side of the stack. Furthermore, a positive electrode plate 110 immediately above a spacer 150 overhangs the spacer on the right side of the stack, while a spacer 150 on the left side of the stack overhangs a positive electrode plate 110 immediately below. In addition, each spacer 150 is flush with the insulating separator in contact.

In general, the spacers 150 are arranged such that spacers on one side of the stack overhang electrode plates of one polarity, while the spacers are overhung by electrode plates of the opposite polarity or their lead portions. As will be described below, such an overhanging arrangement permits the formation of lead portions of opposite polarity of the electrode plate group 100 on opposite lateral sides of the stack, and the overhanging relationship permits an overhanging electrode plate to be shaped about a spacer as a fulcrum support. Such a support provides leverage for shaping an electrode as well as mitigating potential cracking damage to the electrode due to excessive bulging or bending.

The spacer includes a longitudinal edge 152 which defines a bending edge along which the lead portion of an immediately adjacent overhanging electrode plate could be bent. The spacers are aligned so that the bending edges of the spacers are substantially parallel to the free edges of the immediately adjacent electrode plates to obtain a substantially rectangular prismatic electrode plate stack. Specifically, the bending edge is placed underneath the lead portion of the immediate adjacent overhanging electrode plate so that the overhanging lead portion could be bent to converge at a meeting location at which the lead portions of the electrode plates of the same polarity will meet.

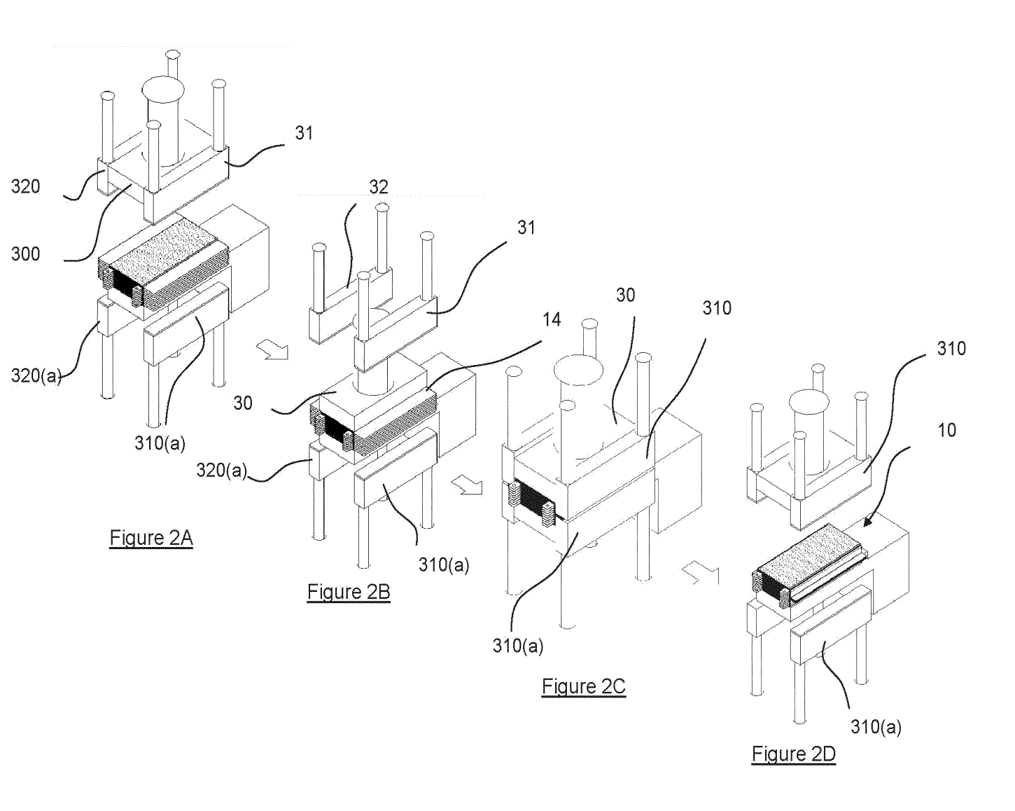

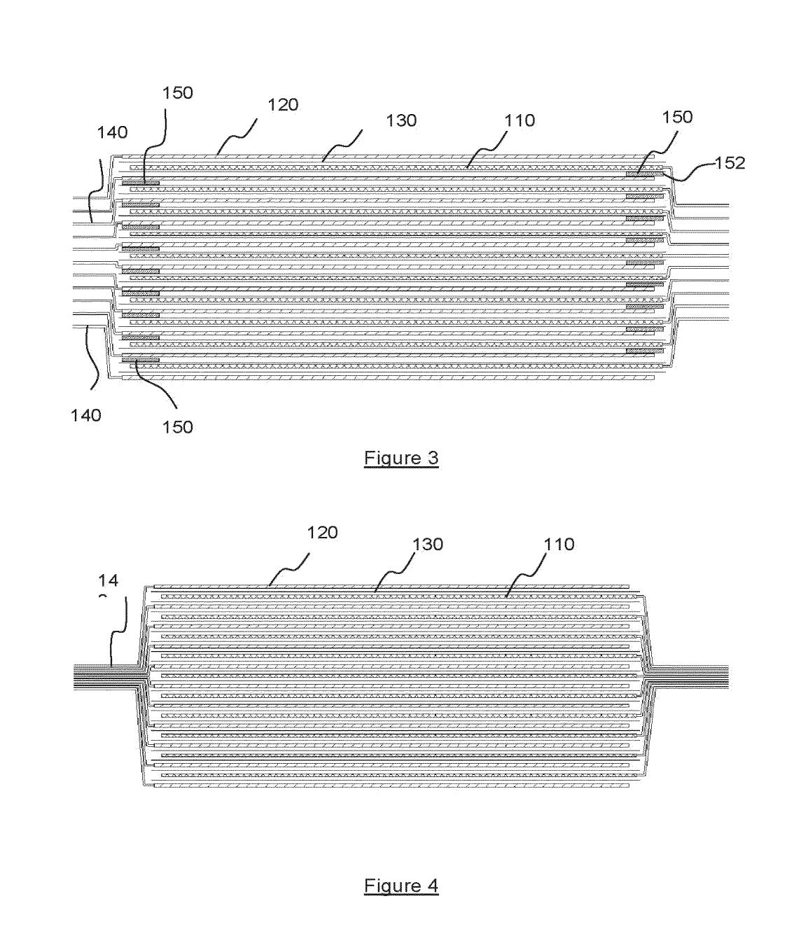

After an electrode plate stack comprising the aligned spacers and as depicted in FIG. 2A has been formed, the electrode plates are firmly held together, for example, under compression by a clamping fixture 300, as shown in FIGS. 2B & 9. The clamping fixture is provided to maintain the loose assembly comprising the electrode plates 110, 120, the insulating sheets 130, and the spacers in position before permanent connections are made.

Next, the overhanging portions are bent to form lead portions of the electrode plate group while the stack is held in place by the clamping fixture 300. The bending is performed by two pair of stamping heads (310, 310(a)) & (320, 320(a)), as shown in FIGS. 2C & 2D. After the lead portions have been formed, the distal ends of the lead portions of the electrode plates of the same polarity are permanently connected, for example, by welding, to form a semi-assembled battery cell as shown in FIGS. 2 &10-12. The permanently connected lead portions of the electrode plates are then connected to the corresponding current collectors to foam a battery cell electrode plate group. More specifically, the lead portions of the positive electrode plate group are connected to the positive current collector, and the lead portions of the negative electrode plate group are connected to the negative current collector. The electrode plates would appear like that of FIG. 3 if the clamping fixture is removed after the electrode plates have been bent. A battery comprising a plurality of cells is then formed by connecting up all the current collectors.

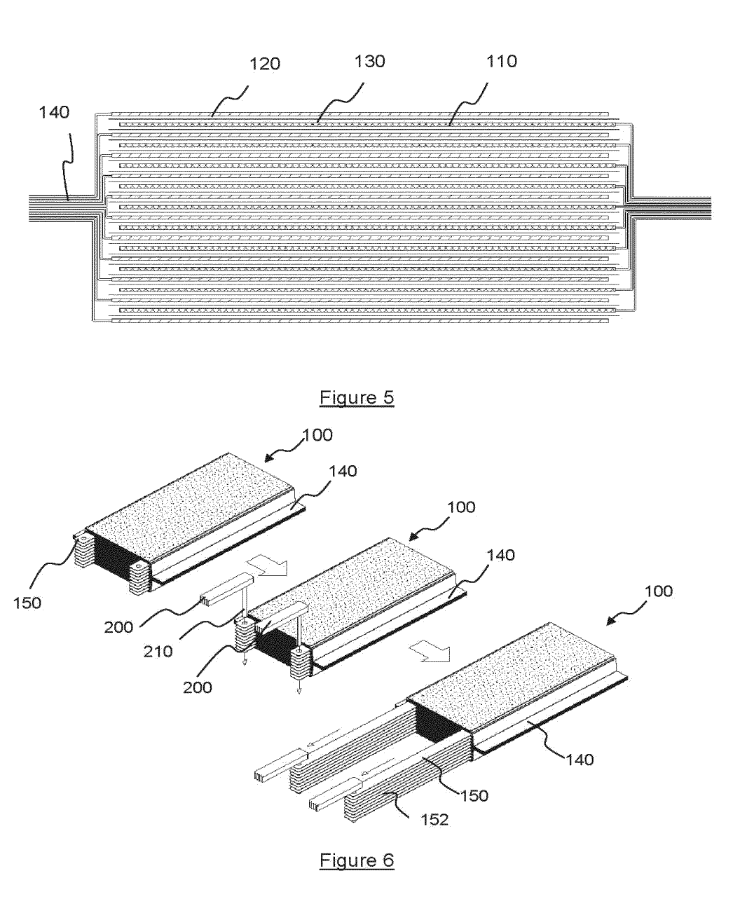

After the lead portions have been joined, the spacers are removed from the electrode plate stack to form a final electrode plate group of FIGS. 4 & 15. To facilitate efficient removal of the spacers, each spacer includes a protruding portion on which an engagement aperture is defined. The apertures of the spacers are arranged and aligned such that when the spacers are duly placed in the pre-bent electrode plate stack, the apertures collectively define a longitudinal bore. The longitudinal bore permits the insertion of a single removal pin 210 which would allow removal of spacers on one side of the electrode plates by a single removal arm 200, as shown in the steps illustrated by FIGS. 6A to 6C. In the connected electrode plate group of FIG. 4, the bent is substantially rounded. In an alternative example of FIG. 5, the bent is substantially angular and at right angle.

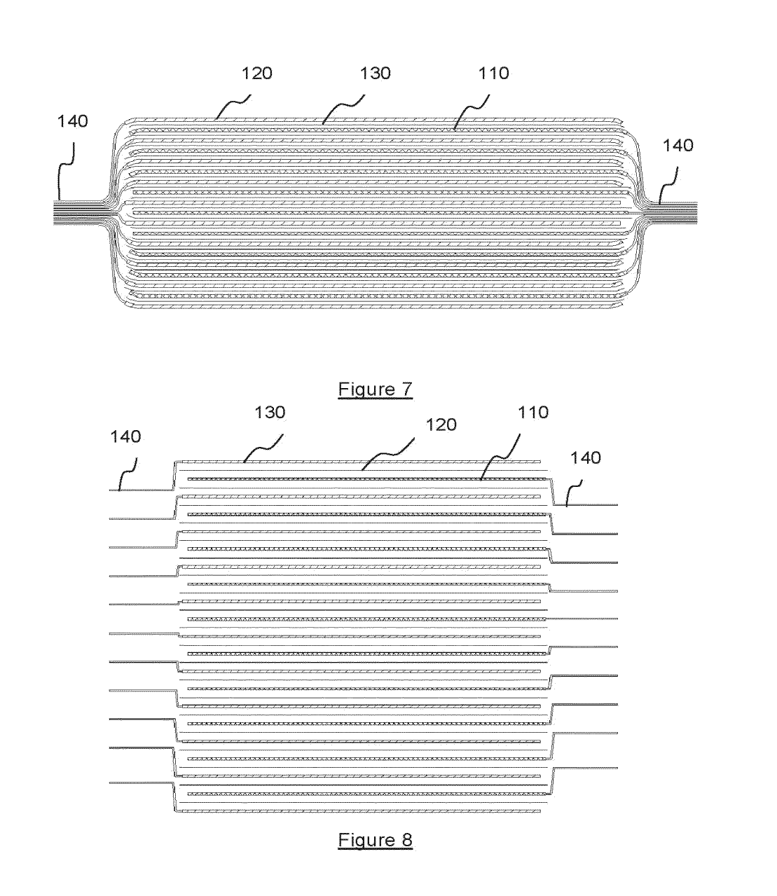

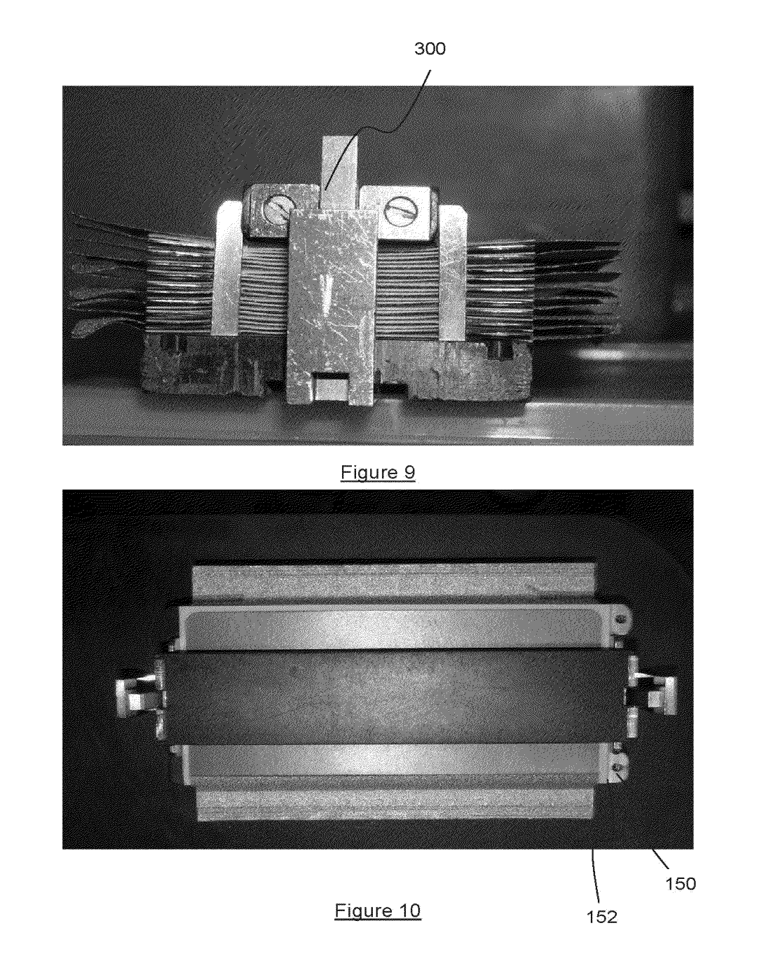

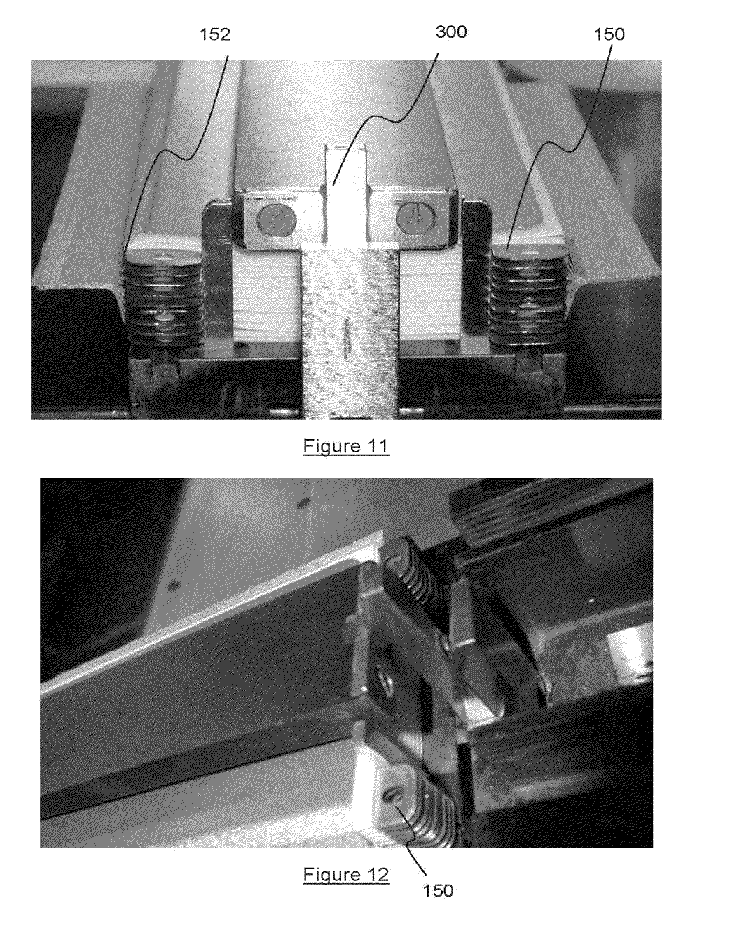

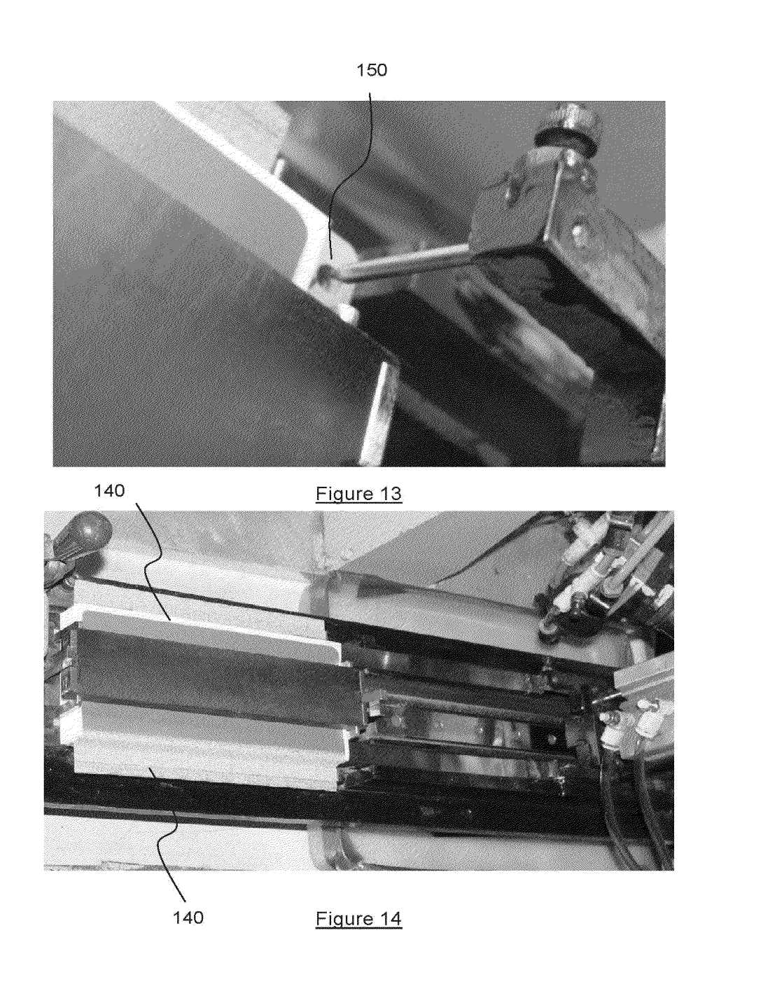

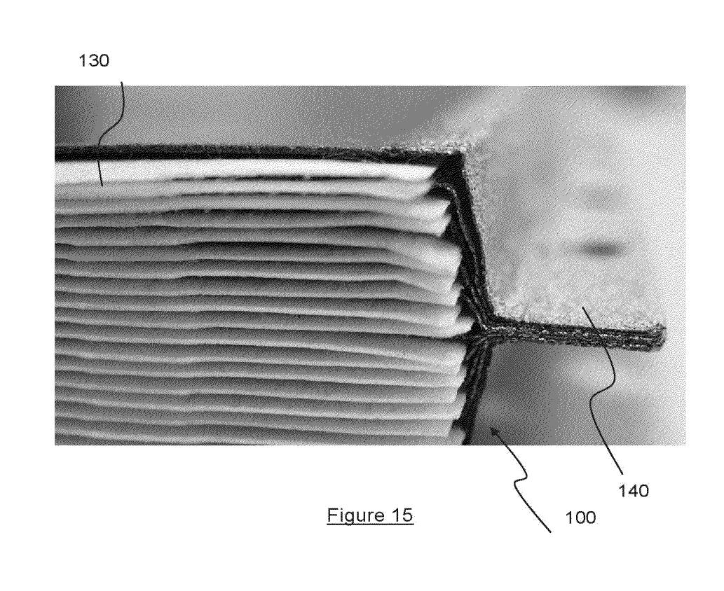

The use of edge forming spacers 150, in particular rigid spacers 150 in combination with the clamping fixture 300 and the stamping heads 310, 320, helps to promote a smooth and rounded transition from the planar active region of an electrode plate to a common joining location at which lead portions of the electrode plates of the same polarity are permanently joined, as depicted in FIG. 7. Insertion of the spacers coupled with bending while the electrode plates and the spacers are held together alleviate the problem of un-desirable bending or cracking of the active portions of the electrode plates. The spacer may be a very thin steel ruler so that their removal would not leave an appreciable gap between the separator and an adjacent electrode plate. The ensemble of steel ruler provides an aligned support about which the lead portions could bend while mitigating possible bulging or cracking damage of the active regions of the electrode plates.

Although the above has been described with reference to a Nickel-Metal-Hydride (NiMH) battery, such a choice of example is only for convenience, because Nickel-Metal-Hydride batteries are widely used and are known to have a superior power density characteristic, is reasonably priced and has a reasonable battery life. It should be appreciated by skilled persons that the description of the present specification applies mutatis mutandis to other types of prismatic batteries without loss of generality. Also, although the bends at the lead portions are substantially angular, it would be appreciated that the bends could be rounded without loss of generality.

Furthermore, while the present invention has been explained by reference to the preferred embodiments described above, it will be appreciated that the embodiments are illustrated as examples to assist understanding of the present invention and are not meant to be restrictive on the scope and spirit of the present invention. Variations or modifications which are obvious or trivial to persons skilled in the art, as well as improvements made on the basis of the present invention, should be considered equivalents of the present invention.

1. A method of forming an electrode plate group of a battery cell or of an electronic component, the electroplate group comprising a stack of positive and negative electrode plates which are alternately stacked and insulated, the method comprising the steps of:
Stacking positive and negative electrode plates alternately with insulators there-between,
Holding or bundling the electrode plates together in a stack,
Shaping the electrode plates or leads thereof such that electrode plates of an electrical polarity could be subsequently joined together to form a lead portion of that electrical polarity,
Connecting electrode plates of the same electrical polarity together such that the positive and negative electrode plates are connected respectively to positive and negative lead portions, and
Connecting the positive and negative lead portions to positive and negative current collectors of the battery cell respectively;
wherein the electrode plates are shaped to form the lead portions while being held in the stack.

2. A method according to claim 1, wherein electrode plates of an electrical polarity are shaped by bending to converge at the lead portion of that electrical polarity while in the stack.

3. A method according to claim 2, wherein each electrode plate is shaped to converge at the lead portion by bending about a straight elongate edge.

4. A method according to claim 1, wherein electrode plates of one electrical polarity in the stack are bent in a single step to converge towards the lead portion of that polarity.

5. A method according to claim 1, wherein positive and negative electrode plates in the stack are bent in a single step to converge respectively towards positive and negative lead portions of the stack.

6. A method according to claim 1, wherein the method comprises the steps of:
Introducing a plurality of spacers into the stack of electrode plates before the electrode plates are held or bundled together, each spacers defining an elongate edge,
Bending the electrode plates about the spacers such that electrode plates of the same electrical polarity converge towards a common joining location,
Joining electrode plates of the same electrical polarity to form a lead portion of that polarity; and
Removing the spacers after the electrode plates having been joined.

7. A method according to claim 6, wherein each spacer is placed intermediate an electrode plate and an insulating sheet.

8. A method according to claims claim 7, wherein each spacer is placed intermediate a positive plate and a negative electrode plate.

9. A method according to claim 8, wherein the stack of electrode plates comprising the spacers are held under compression when the electrode plates are bent to prevent bulging or dislocation of the electrode plates.

10. A method according to claim 6, wherein the spacers are removed in a single step.

11. A method according to claim 6, wherein the method comprises:
Placing the spacers such that each spacer overhangs an electrode plate of one polarity while being overhung by an electrode plate of the opposite polarity;
Bending the overhanging portions of the electrode plates about the corresponding edges of the respective spacers to converge at the common joining location;
Joining the overhanging portions of the electrode plates of the same polarity to form a lead portion of that polarity; and
Connecting the lead portions to the respective current collectors.

12. A method according to claim 6, wherein each spacer is elongate with a rigid rectilinear edge, the rigid rectilinear edge being adapted for bending of an electrode plate or a lead portion thereof such that the bent portion converges towards the common joining location.

13. A method according to claim 12, wherein the rectilinear edge of a spacer is substantially parallel to the edges of the electrode plates in contact.

14. A method according to claim 6, wherein the electrode plates of opposite polarity are separated by an insulating separator, and the spacers are placed such that the rectilinear edges of the spacers are flush with a longitudinal side of an insulating separator in contact.

15. A method according to claim 6, wherein the electrode plates are clamped by a clamping mechanism to form an electrode stack before shaping of the electrode plates, and the method comprises operating the clamping mechanism to compress the electrode plates while the spacers are in place.

16. A method according to claim 6, wherein the method further comprises the step of aligning the spacers in the electrode stack so that the rectilinear edges of the spacers adjacent a current collector are flush.

17. A prismatic battery cell or an electronic component comprising an electrode plate group made according to claim 1.

18. A prismatic battery cell or an electronic component comprising an electrode plate group of alternately stacked positive and negative electrode plates, wherein adjacent electrode plates of opposite polarity are insulated by an insulating separator, and electrode plates of one polarity are bent to converge at a common joining location for connecting together as a lead portion, the lead portion being joined together to a current collector of that one polarity, wherein the electrode plates are bent after the electrode plates are stacked and held or bundled together.

19. A prismatic battery cell or an electronic component according to claim 18, wherein the electrode plate is substantially planar until at the bending edge.

20. A prismatic battery cell or an electronic component according to claim 19, wherein the bend at the bending edge is substantially rounded.

21. A prismatic battery cell or an electronic component according to claim 18, wherein the side of the insulating separator proximal the bend is flush with the bending edge.

22. A prismatic battery cell according to claim 17, wherein the insulating separator overhangs an adjacent electrode plate.

23. A prismatic battery cell according to claim 17, wherein each electrode plate comprises a planar active region and the transition from the planar active region of an electrode plate to the common joining location is round and smooth.
